(19) United States
(12) Patent Application Publication
(10) Pub. No.: US 2024/0076194 A1
(43) Pub. Date: Mar. 7, 2024

(54) HALIDE PRODUCING METHOD

(71) Applicant: Panasonic Intellectual Property Management Co., Ltd., Osaka (JP)

(72) Inventor: HIROSHI ASANO, Osaka (JP)

(21) Appl. No.: 18/504,126

(22) Filed: Nov. 7, 2023

Related U.S. Application Data
(63) Continuation of application No. PCT/JP2022/016862, filed on Mar. 31, 2022.

(30) Foreign Application Priority Data
May 28, 2021 (JP) 2021-089758

(51) Int. Cl. C01D 15/04; H01M 10/0562

(52) U.S. Cl. CPC C01D 15/04; H01M 10/0562; H01M 2300/008

(57) ABSTRACT

A halide producing method according to the present disclosure includes heat-treating a material mixture that is a material containing an MOₓ powder and an NH₄X powder in an inert gas atmosphere or in a vacuum. M represents at least one element selected from the group consisting of rare-earth elements, X represents at least one element selected from the group consisting of F, Cl, Br, and I, x is greater than or equal to 1 and less than or equal to 2, and Requirement (a) or Requirement (b) below is satisfied,

D1≤D2 and D2−D1≤0.5×D2 (a)

D2<D1 and D1−D2≤0.5×D1 (b)

where an average particle diameter of the MOₓ powder is denoted by D1, and an average particle diameter of the NH₄X powder is denoted by D2.

### BACKGROUND

### 1. Technical Field

The present disclosure relates to a halide producing method.

### 2. Description of the Related Art

Z. Anorg. Allg. Chem., 623 (1997), 1352-1356 discloses solid electrolytes such as Li₃YCl₆ and Li₃YBr₆. The solid electrolytes are synthesized through heat treatment by using a vacuum-sealed tube.

International Publication No. 2018/025582 discloses a halide solid electrolyte synthesis method through a mechanochemical milling reaction by using a planetary ball mill.

International Publication No. 2020/136956 discloses a halide producing method in which an oxide is used as a raw material.

### SUMMARY

One non-limiting and exemplary embodiment provides a producing method suitable for decreasing an impurity contained in a halide.

In one general aspect, the techniques disclosed here feature a halide producing method including heat-treating a material mixture that is a material containing an MOₓ powder and an NH₄X powder in an inert gas atmosphere or in a vacuum, wherein M represents at least one element selected from the group consisting of rare-earth elements, X represents at least one element selected from the group consisting of F, Cl, Br, and I, x is greater than or equal to 1 and less than or equal to 2, and Requirement (a) or Requirement (b) below is satisfied,

D1≤D2 and D2−D1≤0.5×D2 (a)

D2<D1 and D1−D2≤0.5×D1 (b)

where an average particle diameter of the MOₓ powder is denoted by D1, and an average particle diameter of the NH₄X powder is denoted by D2.

According to the present disclosure, a producing method suitable for decreasing an impurity contained in a halide can be provided.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a flow chart illustrating an example of a producing method according to a first embodiment;

FIG. 1B is a flow chart illustrating another example of the producing method according to the first embodiment;

FIG. 1C is a flow chart illustrating another example of the producing method according to the first embodiment;

FIG. 1D is a flow chart illustrating another example of the producing method according to the first embodiment;

FIG. 2A is an SEM image of an NH₄Cl raw material powder before pulverization treatment;

FIG. 2B is an SEM image of an Y₂O₃ raw material powder;

FIG. 2C is an SEM image of the NH₄Cl raw material powder after pulverization treatment;

FIG. 3 is a schematic diagram illustrating a pressure forming die used for evaluating the ionic conductivity of a solid electrolyte; and

FIG. 4 is a graph illustrating the Cole-Cole plot obtained by the impedance measurement of a halide solid electrolyte in Example 3.

### DETAILED DESCRIPTIONS

### Underlying Knowledge Forming Basis of the Present Disclosure

Z. Anorg. Allg. Chem., 623 (1997), 1352-1356 discloses halide solid electrolytes such as Li₃YCl₆ and Li₃YBr₆. However, the solid electrolytes are synthesized through heat treatment by using a vacuum-sealed tube. The ionic conductivity of the synthesized solid electrolyte is low, and the ionic conductivity is not recognized at room temperature. In this regard, heat treatment by using the vacuum-sealed tube is unsuitable for mass production.

International Publication No. 2018/025582 discloses a halide solid electrolyte synthesis method through a mechanochemical milling reaction by using a planetary ball mill. This method is unsuitable for mass production, and, in addition, the yield is low.

International Publication No. 2020/136956 discloses a halide solid electrolyte synthesis method in which an oxide is used as a raw material. This method can be applied to mass production, but to sufficiently react the raw materials with each other, raw materials are used in an amount out of the stoichiometric composition. Consequently, the raw materials tend to remain behind, and the ionic conductivity intrinsic to the halide solid electrolyte is not obtained.

In consideration of the above-described circumstances, the present inventor performed research on a producing method suitable for decreasing an impurity contained in a halide.

The embodiments according to the present disclosure will be described below with reference to the drawings. The following embodiments are exemplifications, and the present disclosure is not limited to the following embodiments.

### First Embodiment

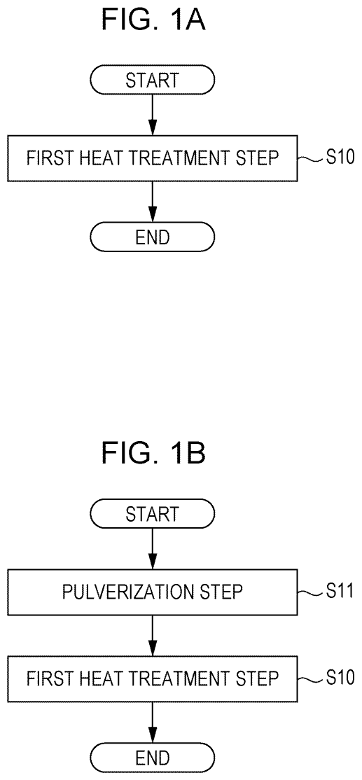

FIG. 1A is a flow chart illustrating an example of a producing method according to a first embodiment.

The producing method according to the first embodiment includes First heat treatment step S10.

In First heat treatment step S10, a material mixture that is a material containing an MOₓ powder and an NH₄X powder is heat-treated in an inert gas atmosphere or in a vacuum. Herein, M represents at least one element selected from the group consisting of rare-earth elements, X represents at least one element selected from the group consisting of F, Cl, Br, and I, and x is greater than or equal to 1 and less than or equal to 2.

Requirement (a) or Requirement (b) below is satisfied,

D1≤D2 and D2−D1≤0.5×D2 (a)

D2<D1 and D1−D2≤0.5×D1 (b)

where an average particle diameter of the MOₓ powder is denoted by D1, and an average particle diameter of the NH₄X powder is denoted by D2.

According to the above-described configuration, since the average particle diameters are close to each other, the materials readily react with each other. Consequently, an impurity contained in the intended halide can be decreased. In addition, the producing method according to the present disclosure is suitable for mass production since a so-called heat treatment method is adopted. In this regard, the heat treatment method may be used in combination with another synthesis method such as mechanical milling.

The material mixture is obtained by mixing raw material powders such as the MOₓ powder and the NH₄X powder.

In First heat treatment step S10, MOₓ (that is, a rare-earth oxide) reacts with NH₄X (that is, an ammonium halide).

For example, when M represents Y, and X represents Cl, that is, when Y₂O₃ reacts with NH₄Cl, a reaction denoted by Formula (1) below proceeds.

Y₂O₃+12NH₄Cl→2(NH₄)₃YCl₆+6NH₃+3H₂O (1)

Each of the average particle diameter D1 of the MOₓ powder and the average particle diameter D2 of the NH₄X powder may be less than or equal to 100 μm. According to such a configuration, MOₓ and NH₄X readily react with each other. There is no particular limitation regarding the lower limit value of each of the average particle diameter D1 of the MOₓ powder and the average particle diameter D2 of the NH₄X powder. The lower limit value of each powder is, for example, 0.05 μm.

The material mixture may contain at least two types of MOₓ in which the types of M differ from each other. The material mixture may contain at least two types of NH₄X in which the types of X differ from each other.

The material mixture may contain a material other than MOₓ and NH₄X. In such an instance, all materials contained in the material mixture may have average particle diameters close to each other. For example, the average particle diameter of the material having the largest average particle diameter of the materials contained in the material mixture is denoted by Dₘₐₓ, and the average particle diameter of the material having the smallest average particle diameter of the materials contained in the material mixture is denoted by Dₘᵢₙ. In such an instance, the difference between the average particle diameters (Dₘₐₓ−Dₘᵢₙ) may be less than or equal to (0.5×Dₘₐₓ). According to such a configuration, the materials contained in the material mixture readily react with each other.

The material mixture may be composed of MOₓ and NH₄X. “Be composed of MOₓ and NH₄X” means that other components except for incidental impurities are intentionally not added.

To further enhance the reactivity of the material mixture, the difference between the average particle diameters (Dₘₐₓ−Dₘᵢₙ) may be less than or equal to (0.3×Dₘₐₓ), may be less than or equal to (0.1×Dₘₐₓ), or may be less than or equal to (0.05×Dₘₐₓ).

All materials contained in the material mixture may have an average particle diameter of less than or equal to 100 μm. According to such a configuration, the materials contained in the material mixture readily react with each other. The lower limit value of the average particle diameter is, for example, 0.05 μm.

All materials contained in the material mixture may have an average particle diameter of less than or equal to 50 μm. According to such a configuration, the materials contained in the material mixture more readily react with each other.

The average particle diameter of the material such as MOₓ or NH₄X means a particle diameter at a cumulative volume of 50% in the particle size distribution measured using a laser diffraction and scattering particle size distribution analyzer, that is, a median diameter (D50).

The producing method according to the present embodiment may include a step of pulverizing the material contained in the material mixture.

FIG. 1B is a flow chart illustrating another example of the producing method according to the first embodiment.

The producing method according to the first embodiment may include Pulverization step S11.

The material contained in the material mixture is pulverized before First heat treatment step S10. That is, Pulverization step S11 is performed before First heat treatment step S10.

In Pulverization step S11, at least one of the plurality of materials to be contained in the material mixture is pulverized. Consequently, the average particle diameter of the material such as MOₓ or NH₄X can be adjusted.

For example, it is assumed that the plurality of materials to be contained in the material mixture include a first material and a second material and that the average particle diameter of the first material be greater than the average particle diameter of the second material. In such an instance, the first material is pulverized in advance so as to make the average particle diameter of the first material close to the average particle diameter of the second material. Thereafter, the material mixture is prepared by mixing the pulverized first material with the second material. Not only the first material but also the second material may be pulverized. In an example, the first material is MOₓ and the second material is NH₄X. In another example, the first material is NH₄X and the second material is MOₓ.

There is no particular limitation regarding the pulverization method, and mechanical pulverization may be performed. Regarding the pulverization method, a method by using a pulverization apparatus such as a ball mill, a pot mill, a speed mill, or a jet mill may be adopted. Pulverization may be performed by a single method, or pulverization may be performed by combination of a plurality of methods.

The average particle diameter of a material soluble in a solvent can also be decreased through dissolution and reprecipitation.

FIG. 1C is a flow chart illustrating another example of the producing method according to the first embodiment.

The producing method according to the first embodiment may include Dissolution step S12 and Removal step S13.

Obtaining of a solution by dissolving, in a solvent, the material contained in the material mixture and removing of the solvent from the solution are performed before heat-treating of the material mixture. That is, Dissolution step S12 and Removal step S13 are performed before First heat treatment step S10.

In Dissolution step S12, at least one of a plurality of materials to be contained in the material mixture is dissolved in a solvent. Subsequently, in Removal step S13, the solvent is removed from the solution. Consequently, the average particle diameter of the material such as MOₓ or NH₄X can be adjusted.

For example, it is assumed that the plurality of materials to be contained in the material mixture include a first material and a second material and that the average particle diameter of the first material be greater than the average particle diameter of the second material. In such an instance, a solution is produced by dissolving the first material in a solvent. Thereafter, the solvent is removed from the solution to reprecipitate the first material. Consequently, the average particle diameter of the first material is made close to the average particle diameter of the second material. Subsequently, the first material is mixed with the second material. The second material may be dissolved and reprecipitated separately from the first material. Alternatively, Dissolution step S12 and Removal step S13 may be performed after all the materials to be contained in the material mixture are mixed.

In an example, the first material is NH₄X and the second material is MOₓ. In another example, the first material is MOₓ and the second material is NH₄X. In particular, NH₄X is an ionic compound and, therefore, can be sufficiently dissolved in various solvents.

The solvent may be an inorganic solvent or may be an organic solvent.

Pulverization step S11 may be performed after Dissolution step S12 and Removal step S13 are performed. Alternatively, Dissolution step S12 and Removal step S13 may be performed after Pulverization step S11 is performed.

The materials having an adjusted average particle diameter are precisely weighed and mixed so as to ensure a stoichiometric composition in accordance with a chemical reaction formula for obtaining a predetermined composition.

To obtain a homogeneous material mixture, the producing method according to the present embodiment may include a mixing step. There is no particular limitation regarding the mixing method, and a mixing apparatus such as a ball mill, a pot mill, a V-type mixer, a double-cone type mixer, or an automatic mortar can be used.

The material mixture is heat-treated in First heat treatment step S10 so that a rare-earth halogenated ammonium salt is obtained.

First heat treatment step S10 is performed in an inert gas atmosphere or in a vacuum. Examples of the inert gas atmosphere include atmospheres containing a helium gas, an argon gas, or a nitrogen gas, or a gas mixture of these. When First heat treatment step S10 is performed in a vacuum, the degree of vacuum is, for example, 10⁻¹ Pa to 10⁻⁸ Pa.

In First heat treatment step S10, the heat treatment temperature (atmosphere temperature) may be 200° C. to 250° C.

In First heat treatment step S10, the heat treatment time may be 1 hour to 36 hours.

The heat treatment temperature and the heat treatment time are appropriately changed in accordance with the material used and the type of a predetermined rare-earth halogenated ammonium salt.

Whether the reaction of the material mixture is completed, that is, whether the predetermined composition is obtained can be examined by identification of the produced phase by using an X-ray diffraction apparatus or by measurement of a mass change based on the chemical reaction formula. The composition can be identified by a method such as ICP emission spectrometry, ICP mass spectrometry, or X-ray fluorescence spectrometry.

A halide is obtained by reacting the rare-earth halogenated ammonium salt obtained in First heat treatment step S10 with a lithium halide. The halide is, for example, a halide solid electrolyte.

For example, when (NH₄)₃YCl₆ serving as the rare-earth halogenated ammonium salt reacts with LiBr serving as a lithium halide, a reaction denoted by Formula (2) below proceeds.

(NH₄)₃YCl₆+3LiBr→Li₃YBr₃Cl₃+3NH₄Cl (2)

According to the above-described reaction, Li₃YBr₃Cl₃ is obtained. That is, a compound composed of lithium, a rare-earth element, and halogen is obtained.

Requirement (c1) or Requirement (d1) may be satisfied where the average particle diameter of the rare-earth halogenated ammonium salt powder is denoted by D3, and the average particle diameter of the lithium halide powder is denoted by D4. According to such a configuration, the reaction denoted by Formula (2) tends to proceed.

D3≤D4 and D4−D3≤0.5×D4 (c1)

D4<D3 and D3−D4≤0.5×D3 (d1)

To further facilitate the reaction denoted by Formula (2), Requirement (c2) or Requirement (d2) may be satisfied.

D3≤D4 and D4−D3≤0.3×D4 (c2)

D4<D3 and D3−D4≤0.3×D3 (d2)

To further facilitate the reaction denoted by Formula (2), Requirement (c3) or Requirement (d3) may be satisfied.

D3≤D4 and D4−D3≤0.1×D4 (c3)

D4<D3 and D3−D4≤0.1×D3 (d3)

To further facilitate the reaction denoted by Formula (2), Requirement (c4) or Requirement (d4) may be satisfied.

D3≤D4 and D4−D3≤0.05×D4 (c4)

D4<D3 and D3−D4≤0.05×D3 (d4)

The average particle diameter of each of the rare-earth halogenated ammonium salt and the lithium halide may be less than or equal to 100 μm or may be less than or equal to 50 μm. Consequently, the above-described reaction readily proceeds. The average particle diameter of each of the rare-earth halogenated ammonium salt and the lithium halide may be greater than or equal to 0.05 μm.

The method for adjusting the average particle diameter of the material, the method for evaluating the average particle diameter, and the method for mixing the material are as described above.

The reaction between the rare-earth halogenated ammonium salt obtained in First heat treatment step S10 and the lithium halide may be performed through heat treatment. For example, the reaction denoted by Formula (2) may be performed through heat treatment.

FIG. 1D is a flow chart illustrating another example of the producing method according to the first embodiment.

The producing method according to the first embodiment may include Second heat treatment step S20.

Second heat treatment step S20 is performed after First heat treatment step S10.

In Second heat treatment step S20, a material containing the halide obtained by heat-treating the material mixture in First heat treatment step S10 and LiZ is heat-treated. Herein, Z represents at least one element selected from the group consisting of F, Cl, Br, and I.

Second heat treatment step S20 may be performed in an inert gas atmosphere or in a vacuum. Examples of the inert gas atmosphere include atmospheres containing a helium gas, an argon gas, or a nitrogen gas, or a gas mixture of these. When Second heat treatment step S20 is performed in a vacuum, the degree of vacuum is, for example, 10⁻¹ Pa to 10⁻⁸ Pa.

In Second heat treatment step S20, the heat treatment temperature (atmosphere temperature) may be 400° C. to 700° C.

In Second heat treatment step S20, the heat treatment time may be 1 hour to 36 hours.

The heat treatment temperature and the heat treatment time are appropriately changed in accordance with the material used and the type of a predetermined halide.

Whether the heat treatment reaction is completed can be examined in the manner akin to that in the first heat treatment step.

A compound containing lithium, a rare-earth element, and halogen is obtained by reacting the rare-earth halogenated ammonium salt with a lithium halide. The resulting compound may be a solid electrolyte. In particular, The resulting compound may be a halide solid electrolyte.

The average particle diameter of the halide solid electrolyte may be less than or equal to 100 μm, desirably less than or equal to 10 μm, and further desirably less than or equal to 1 μm. There is no particular limitation regarding the lower limit value of the average particle diameter of the halide solid electrolyte. The lower limit value is, for example, 0.05 μm. There is no particular limitation regarding the pulverization method to realize such an average particle diameter. Regarding the pulverization method, a method by using a pulverization apparatus such as a ball mill, a pot mill, a speed mill, or a jet mill may be adopted. Pulverization may be performed by a single method, or pulverization may be performed by combination of a plurality of methods.

### EXAMPLES

The present disclosure will be described below in more detail with reference to the examples and the comparative examples. In the following exemplifications, the halide produced by the method according to the present disclosure was produced as a solid electrolyte and was evaluated.

### Example 1

Production of (NH₄)₃YCl₆

(NH₄)₃YCl₆ was synthesized as a raw material for a halide solid electrolyte.

Initially, commercially available Y₂O₃ and NH₄Cl were prepared.

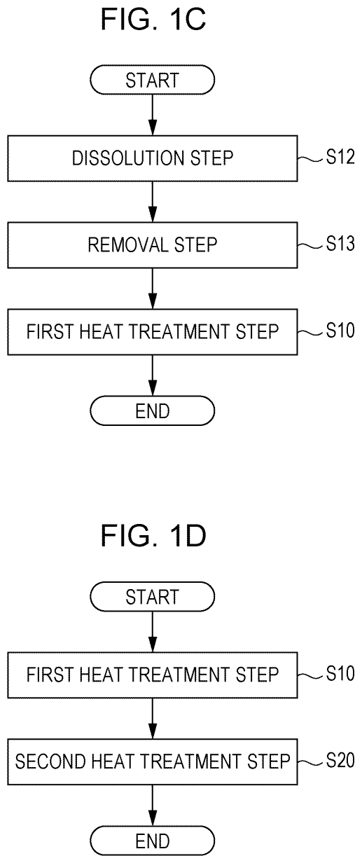

FIG. 2A is an SEM image of an NH₄Cl raw material powder before pulverization treatment. FIG. 2B is an SEM image of an Y₂O₃ raw material powder. As illustrated in FIG. 2A and FIG. 2B, the average particle diameters of the NH₄Cl raw material powder and the Y₂O₃ raw material powder were 1 mm and 0.5 μm, respectively.

To adjust the difference between the average particle diameters to be within 50%, that is, to satisfy Requirement (a) or Requirement (b) described above, the NH₄Cl raw material powder was pulverized using a hammer mill.

FIG. 2C is an SEM image of the NH₄Cl raw material powder after pulverization treatment. The average particle diameter of the NH₄Cl raw material powder after pulverization was 0.8 μm. Therefore, the difference between the average particle diameter of the NH₄Cl raw material powder and the average particle diameter of the Y₂O₃ raw material powder was 0.3 μm. This value was within 50% of the average particle diameter of the NH₄Cl raw material powder.

The Y₂O₃ raw material powder and the pulverized NH₄Cl raw material powder were weighed so as to ensure the molar ratio Y₂O₃:NH₄Cl=1:12. The raw material powders were dry-mixed using a tumbler mixer. Consequently, a material mixture was obtained. The resulting material mixture was placed into an aluminum crucible and was kept in a nitrogen atmosphere at 200° C. for 15 hours. Consequently, (NH₄)₃YCl₆ according to Example 1 was obtained. The mass decrease rate was calculated by dividing the mass of (NH₄)₃YCl₆ obtained through heat treatment by the total mass of the material mixture measured before heat treatment.

### Example 2

Production of (NH₄)₃YCl₆

(NH₄)₃YCl₆ according to Example 2 was obtained in the manner akin to that in Example 1 except for the molar ratio of the raw material powder contained in the material mixture.

In Example 2, the Y₂O₃ raw material powder and the pulverized NH₄Cl raw material powder were weighed so as to ensure the molar ratio Y₂O₃:NH₄Cl=1:12.6. The raw material powders were dry-mixed using a tumbler mixer. Consequently, a material mixture was obtained. The molar ratio Y₂O₃:NH₄Cl=1:12.6 is a molar ratio in which NH₄Cl is excessive by 5% relative to the stoichiometric ratio.

In Example 2, the mass decrease rate was calculated in the manner akin to that in Example 1.

### Example 3

### Production of Halide Solid Electrolyte

A halide solid electrolyte was synthesized using (NH₄)₃YCl₆ according to Example 1.

In an argon atmosphere having a dew point of lower than or equal to −60° C., (NH₄)₃YCl₆ according to Example 1 and LiBr were prepared so as to ensure the molar ratio (NH₄)₃YCl₆:LiBr=1:3. The materials were mixed using a tumbler mixer. The resulting material mixture was placed into an aluminum crucible. Two crucibles filled with the material mixture were prepared and kept at 500° C. for 1 hour in an electric furnace filled with an argon atmosphere. The two crucibles were placed at Place 1 and Place 2, respectively, in the electric furnace.

To examine reproducibility, the above-described heat treatment was performed 4 times. In Table 2, the nth heat treatment was expressed as “Heat treatment n”.

The resulting heat-treated material was pulverized in an agate mortar. Consequently, a halide solid electrolyte according to Example 3 was obtained.

The Li content per unit mass of the halide solid electrolyte according to Example 3 was measured by an atomic absorption analysis method. The Y content of the halide solid electrolyte according to Example 3 was measured by ICP emission spectrometry. The molar ratio Li:Y was calculated from the Li content and the Y content obtained by these measurements. As a result, the molar ratio Li:Y was 3:1. This value was in accord with the value calculated from the charge ratio of the raw material powders.

### Evaluation of Ionic Conductivity

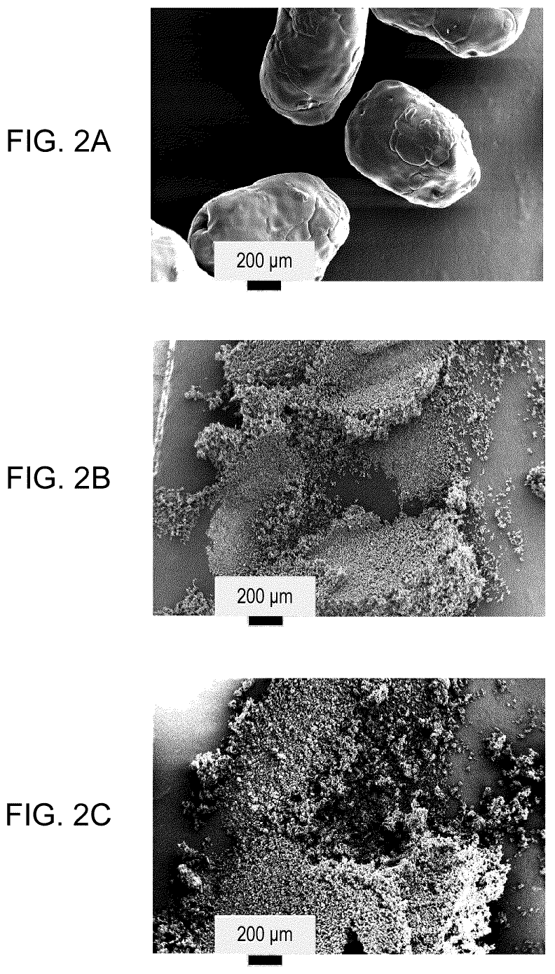

FIG. 3 is a schematic diagram illustrating a pressure forming die 300 used for evaluating the ionic conductivity of a solid electrolyte.

The pressure forming die 300 included a punch upper portion 301, a die 302, and a punch lower portion 303. Each of the punch upper portion 301 and the punch lower portion 303 was formed of electron-conductive stainless steel. The die 302 was formed of insulating polycarbonate.

The ionic conductivity of the halide solid electrolyte according to Example 3 was measured using the pressure forming die 300 by the following method.

In a dry atmosphere having a dew point of lower than or equal to −60° C., the halide solid electrolyte powder according to Example 3 (that is, a solid electrolyte powder 101 in FIG. 3) was introduced into the interior of the pressure forming die 300. A pressure of 400 MPa was applied to the halide solid electrolyte powder 101 according to Example 3 by using the punch upper portion 301 and the punch lower portion 303.

The punch upper portion 301 and the punch lower portion 303 were coupled to a potentiostat (VersaSTA4 produced by Princeton Applied Research) equipped with a frequency response analyzer while the pressure was applied. The punch upper portion 301 was coupled to a working electrode and a potential-measuring terminal. The punch lower portion 303 was coupled to a counter electrode and a reference electrode. The impedance of the solid electrolyte was measured at room temperature by an electrochemical impedance measuring method.

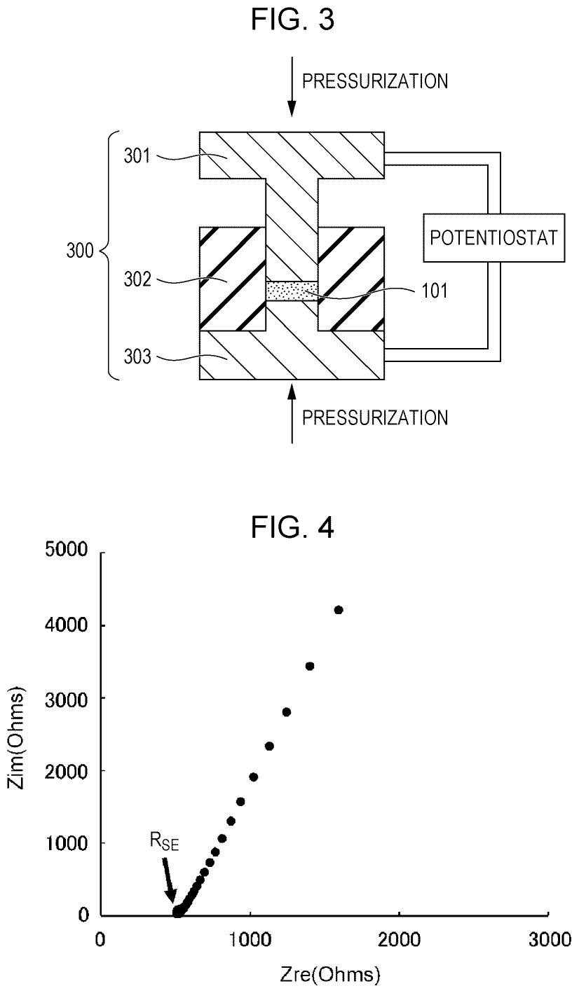

FIG. 4 is a graph illustrating the Cole-Cole plot obtained by the impedance measurement of the halide solid electrolyte according to Example 3.

In FIG. 4, a real number of the impedance at a measurement point at which the absolute value of the phase of the complex impedance was minimum was assumed to be the resistance value of the halide solid electrolyte with respect to the ionic conduction. Regarding the real number, refer to Allow R_{SE} illustrated in FIG. 4. The ionic conductivity was calculated on the basis of Formula (3) below by using the resistance value.

σ=(R_{SE}×S/t)⁻¹ (3)

Herein, σ represents ionic conductivity. S represents a contact area between the halide solid electrolyte and the punch upper portion 301. S is equal to the cross-sectional area of a hollow portion of the die 302 in FIG. 3. R_{SE} represents the resistance value of the solid electrolyte in the impedance measurement. t represents the thickness of the solid electrolyte. In FIG. 3, t represents the thickness of a layer formed from the solid electrolyte powder 101.

### Comparative Example 1

Production of (NH₄)₃YCl₆

In Comparative example 1, pulverization treatment of the NH₄Cl raw material powder was not performed. (NH₄)₃YCl₆ according to Comparative example 1 was obtained in the manner akin to that in Example 1 except for the above.

In Comparative example 1, the mass decrease rate was calculated in the manner akin to that in Example 1.

### Comparative Example 2

Production of (NH₄)₃YCl₆

In Comparative example 2, pulverization treatment of the NH₄Cl raw material powder was not performed. (NH₄)₃YCl₆ according to Comparative example 2 was obtained in the manner akin to that in Example 2 except for the above.

In Comparative example 2, the mass decrease rate was calculated in the manner akin to that in Example 1.

### Comparative Example 3

### Production of Halide Solid Electrolyte

A halide solid electrolyte according to Comparative example 3 was obtained in the manner akin to that in Example 3 except that (NH₄)₃YCl₆ according to Comparative example 1 was used instead of (NH₄)₃YCl₆ according to Example 1. The material mixture containing (NH₄)₃YCl₆ and LiBr was placed into two aluminum crucibles. The two crucibles were placed adjoining the two alumina crucibles placed in the electric furnace in Example 3. Consequently, the material mixture was heat-treated.

### Evaluation of Ionic Conductivity

The ionic conductivity of the halide solid electrolyte according to Comparative example 3 was measured in the manner akin to that in Example 3.

Table 1 presents the mass decrease rates in Example 1, Example 2, Comparative example 1, and Comparative example 2.

TABLE 1

| | | Mass decrease rate based on |
|---|---|---|
| | Mass decrease rate | chemical reaction formula |
| | (experimental value) | (theoretical value) |
| | (%) | (%) |
| Example 1 | −18.02 | −18.01 |
| Example 2 | −17.23 | −17.37 |
| Comparative example 1 | −16.51 | −18.01 |
| Comparative example 2 | −16.00 | −17.37 |

### Consideration

As clearly presented in Table 1, the mass decrease rate was substantially in accord with the theoretical value since the difference in the average particle diameter between the NH₄Cl raw material powder and the Y₂O₃ powder was decreased due to the pulverization treatment of the NH₄Cl raw material powder being performed in advance. That is, an impurity could be decreased.

In this regard, the theoretical value of the mass decrease rate was calculated on the basis of the following chemical reaction formula. That is, NH₃ and H₂O correspond to the decreased mass.

Y₂O₃+12NH₄Cl+xNH₄Cl→2(NH₄)₃YCl₆+xNH₄Cl+6NH₃+3H₂O (x: excess NH₄Cl)

On the other hand, regarding Comparative examples 1 and 2 in which the pulverization treatment was not performed in advance, it is conjectured that a portion of the raw material remained since the reaction did not sufficiently proceed.

Table 2 presents ionic conductivity of the solid electrolytes according to Example 3 and Comparative example 3.

TABLE 2

| | | Ionic conductivity | | Example 3/ |
|---|---|---|---|---|
| | | (mS/cm) | | Comparative |
| | | | Comparative | example 3 |
| | | Example 3 | example 3 | (%) |
| Heat | Place 1 | 2.178 | 1.966 | 110.8 |
| treatment 1 | Place 2 | 2.055 | 1.667 | 123.3 |
| Heat | Place 1 | 1.968 | 1.893 | 104.0 |
| treatment 2 | Place 2 | 1.688 | 1.620 | 104.2 |
| Heat | Place 1 | 1.495 | 1.383 | 108.1 |
| treatment 3 | Place 2 | 1.396 | 1.330 | 105.0 |
| Heat | Place 1 | 2.009 | 1.639 | 122.6 |
| treatment 4 | Place 2 | 1.884 | 1.672 | 112.7 |

### Consideration

As clearly presented in Table 2, the halide solid electrolyte according to Example 3 had higher ionic conductivity than the halide solid electrolyte according to Comparative example 3. Further, this result was not in accordance with the heat treatment place. It is conjectured that, in the comparative example, the ionic conductivity was low due the influence of an unreacted material remaining in (NH₄)₃YCl₆ serving as the raw material. The amount of impurity contained in the halide solid electrolyte in the example was small, and the ionic conductivity intrinsic to the halide solid electrolyte was exhibited.

From the above-described results, it is understood that the solid electrolyte synthesized by the producing method according to the present disclosure exhibits high lithium ion conductivity.

In this regard, it is predicted that, when M in MOₓ is a rare-earth element other than Y, when X in NH₄X is a halogen element other than Cl, or when Z in LiZ is a halogen element other than Cl, the same effects as the effects of Examples 1 to 3 are obtained. The reason for this is that, in general, compounds composed of elements in the same group have analogous physical properties, and, therefore, the same effects can be expected even when the element species is changed. It was actually ascertained that a predetermined compound was obtained even when NH₄Br was used.

The producing method according to the present disclosure can be utilized as, for example, a solid electrolyte producing method. In addition, the solid electrolyte produced by the producing method according to the present disclosure can be utilized for, for example, a battery (for example, an all-solid-state secondary battery).

What is claimed is:

1. A halide producing method comprising:
heat-treating a material mixture that is a material containing an MOₓ powder and an NH₄X powder in an inert gas atmosphere or in a vacuum,
wherein M represents at least one element selected from the group consisting of rare-earth elements,
X represents at least one element selected from the group consisting of F, Cl, Br, and I,
x is greater than or equal to 1 and less than or equal to 2, and
Requirement (a) or Requirement (b) below is satisfied,
D1≤D2 and D2−D1≤0.5×D2 (a)
D2<D1 and D1−D2≤0.5×D1 (b)
where an average particle diameter of the MOₓ powder is denoted by D1, and an average particle diameter of the NH₄X powder is denoted by D2.

2. The producing method according to claim 1,
wherein each of the average particle diameter D1 of the MOₓ powder and the average particle diameter of the NH₄X powder is less than or equal to 100 μm.

3. The producing method according to claim 1, further comprising:
pulverizing at least one material selected from the group consisting of a plurality of materials to be contained in the material mixture,
wherein the pulverizing of the at least one material is performed before preparing of a material mixture and the heat-treating of a material mixture.

4. The producing method according to claim 1, further comprising:
obtaining a solution by dissolving, in a solvent, the at least one material selected from the group consisting of a plurality of materials to be contained in the material mixture; and
removing the solvent from the solution,
wherein the obtaining of a solution and the removing of the solvent are performed before the heat-treating of a material mixture.

5. The producing method according to claim 1, further comprising:
heat-treating a material containing a halide obtained by the heat-treating of a material mixture and LiZ,
wherein Z represents at least one element selected from the group consisting of F, Cl, Br, and I.
